(19) United States
(12) Patent Application Publication
(10) Pub. No.: US 2012/0206444 A1
(43) Pub. Date: Aug. 16, 2012

(54) DISPLAY AND DISPLAYING METHOD

(75) Inventors: Shuichi Takahashi, Kanagawa (JP); Keita Ishikawa, Tokyo (JP); Yota Komoriya, Tokyo (JP); Takanori Ishikawa, Saitama (JP); Kazunari Yoshifuji, Tokyo (JP)

(73) Assignee: SONY CORPORATION, Tokyo (JP)

(21) Appl. No.: 13/364,106

(22) Filed: Feb. 1, 2012

(30) Foreign Application Priority Data
Feb. 10, 2011 (JP) 2011-027368

(51) Int. Cl. G06T 15/00

(52) U.S. Cl. 345/419

(57) ABSTRACT

Favorable stereoscopic display is allowed to be performed with, for example, intended magnitude of depth perception irrespective of a viewing distance. A display includes: a display section displaying a stereoscopic image based on stereoscopic image data; a detection section detecting a viewing distance of a viewer; and an adjustment section modifying magnitude of parallax of the stereoscopic image data from first magnitude of parallax to second magnitude of parallax, in which the adjustment section modifies a correspondence relationship between the first magnitude of parallax and the second magnitude of parallax depending on the detected viewing distance.

### CROSS REFERENCES TO RELATED APPLICATIONS

The present application claims priority to Japanese Priority Patent Application JP 2011-027368 filed in the Japan Patent Office on Feb. 10, 2011, the entire content of which is hereby incorporated by reference.

### BACKGROUND

The present technology relates to a display and a displaying method in which stereoscopic display is performed with use of a plurality of parallax images having parallax therebetween.

Techniques of performing stereoscopic display include a glass system with use of glasses for stereoscopic vision and a naked-eye system capable of achieving stereoscopic vision by naked eyes without glasses for stereoscopic vision. A typical glass system is a shatter glass system using shutter glasses with a left-eye shutter and a right-eye shutter. In the shutter glass system, a left-eye parallax image and a right-eye parallax image are alternately displayed on a two-dimensional display panel at high speed in a frame-sequential manner. Then, the left-eye shutter and the right-eye shutter are alternately opened and closed in synchronization with switching of the parallax images to allow only the left-eye parallax image and the right-eye parallax image to enter the left eye and a right eye of a viewer, respectively, thereby achieving stereoscopic vision.

On the other hand, typical naked-eye systems include a parallax barrier system and a lenticular lens system. In the parallax barrier system and the lenticular lens system, parallax images for stereoscopic vision (a right-eye image and a left-eye image in the case of two viewpoints) which are spatially separated from one another are displayed on a two-dimensional display panel, and the parallax images are separated by parallax in a horizontal direction by a parallax separation structure to achieve stereoscopic vision. In the parallax barrier system, as the parallax separation structure, a parallax barrier having slit-like openings is used. In the lenticular system, as the parallax separation structure, a lenticular lens including a plurality of cylindrical split lenses arranged in parallel is used.

### SUMMARY

In the case where the above-described stereoscopic display is performed, depth perception (magnitude of depth perception) of stereoscopic vision perceived by a viewer varies depending on magnitude of parallax between parallax images. Japanese Unexamined Patent Application Publication Nos. H9-121370 and 2004-289527 disclose techniques of optimizing magnitude of parallax; however, these optimizing techniques are not necessarily best.

It is desirable to provide a display and a displaying method capable of performing favorable stereoscopic display with, for example, intended magnitude of depth perception irrespective of a viewing distance.

According to an embodiment of the technology, there is provided a display including: a display section displaying a stereoscopic image based on stereoscopic image data; a detection section detecting a viewing distance of a viewer; and an adjustment section modifying magnitude of parallax of the stereoscopic image data from first magnitude of parallax to second magnitude of parallax, in which the adjustment section modifies a correspondence relationship between the first magnitude of parallax and the second magnitude of parallax depending on the detected viewing distance.

According to an embodiment of the technology, there is provided a displaying method including: detecting a viewing distance; modifying magnitude of parallax of stereoscopic image data from first magnitude of parallax to second magnitude of parallax; and displaying a stereoscopic image based on the modified stereoscopic image data, in which in modification to the second magnitude of parallax, a correspondence relationship between the first magnitude of parallax and the second magnitude of parallax is modified depending on the detected viewing distance.

In the display or the displaying method according to the embodiment of the technology, the magnitude of parallax of stereoscopic image data is modified from the first magnitude of parallax to the second magnitude of parallax. At this time, the magnitude of parallax is adjusted to allow a correspondence relationship between the first magnitude of parallax and the second magnitude of parallax to be modified depending on the viewing distance. Therefore, for example, the magnitude of parallax of the stereoscopic image data is modified depending on the viewing distance to compensate for a decline in viewer's depth perception sensitivity.

In the display or the displaying method according to the embodiment of the technology, the magnitude of parallax of the stereoscopic image data is modified from the first magnitude of parallax to the second magnitude of parallax, and at this time, the correspondence relationship between the first magnitude of parallax and the second magnitude of parallax is modified depending on the viewing distance; therefore, the magnitude of parallax of the stereoscopic image data is allowed to be modified depending on, for example, the viewing distance to compensate for a decline in viewer's depth perception sensitivity. Therefore, irrespective of the viewing distance, favorable stereoscopic display is allowed to be performed with, for example, an intended magnitude of depth perception.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating an example of a whole configuration of a stereoscopic display according to an embodiment of the technology.

FIG. 2 is an explanatory diagram of a geometrical relationship between magnitude of parallax and magnitude of depth perception.

FIG. 3 is an explanatory diagram of a correspondence relationship between magnitude of parallax and magnitude of depth perception with a first example of a method of adjusting magnitude of parallax.

FIG. 4 is an explanatory diagram of a correspondence relationship between magnitude of parallax and magnitude of depth perception with a second example of the method of adjusting magnitude of parallax.

### DETAILED DESCRIPTION

The present application will be described in detail referring to the accompanying drawings according to an embodiment.

### [Whole Configuration of Stereoscopic Display]

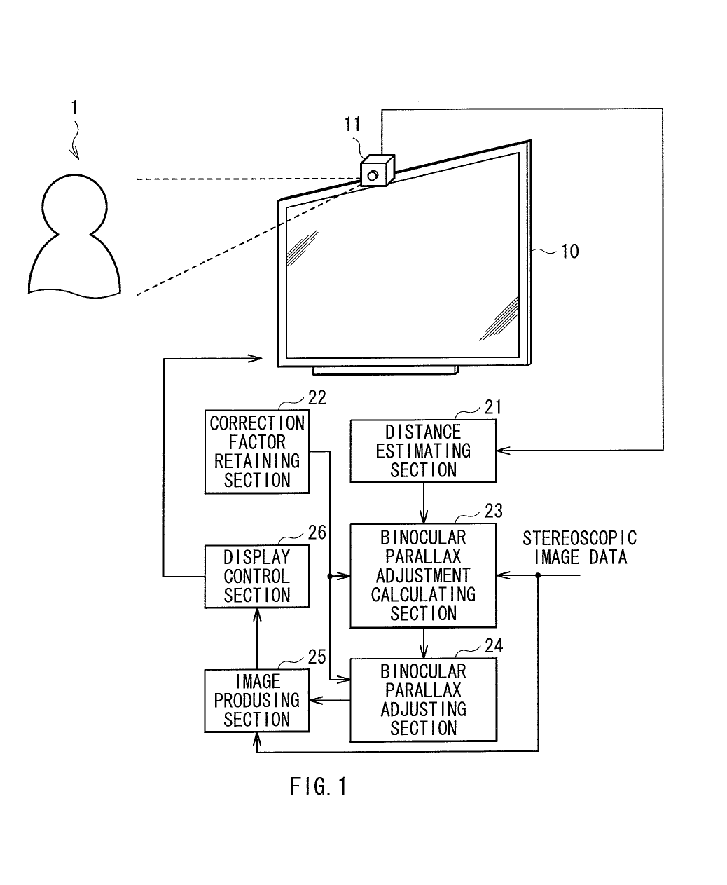

FIG. 1 illustrates a configuration example of a stereoscopic display according to an embodiment of the technology. The stereoscopic display includes a display section 10, a camera 11, a distance estimating section 21, a correction factor retaining section 22, a binocular parallax adjustment calculating section 23, a binocular parallax adjusting section 24, an image producing section 25, and a display control section 26.

The display section 10 is configured of a two-dimensional display such as a liquid crystal display panel, an electroluminescence display panel or a plasma display. A plurality of pixels are two-dimensionally arranged on a display screen of the display section 10. Images are displayed on the display screen of the display section 10 according to a stereoscopic display system of the stereoscopic display.

The stereoscopic display system of the stereoscopic display is not specifically limited. For example, a glass system such as a shutter glass system or a naked-eye system such as a parallax barrier system or a lenticular lens system may be used. For example, in the case of the shutter glass system, parallax images corresponding to two viewpoints, i.e., left and right viewpoints (a left-eye parallax image and a right-eye parallax image) are alternately displayed on the display section 10 in a time-divisional manner. Moreover, for example, in the naked-eye system, a parallax composite image created by combining parallax images corresponding to a plurality of viewpoints (parallax images corresponding to two viewpoints, i.e., left and right viewpoints or parallax images corresponding to a plurality of viewpoints) in one screen is displayed on the display section 10. In other words, a plurality of parallax images which are spatially separated from one another are displayed.

The camera 11 detects a viewer 1 and takes an image of the viewer 1. The distance estimating section 21 estimates and detects a viewing distance of the viewer 1 by analyzing the image taken by the camera 11. The viewing distance is allowed to be detected by, for example, a face tracking technique. It is to be noted that the viewing distance is typically a distance from a display plane of the display section 10 to a central position between both eyes of the viewer 1.

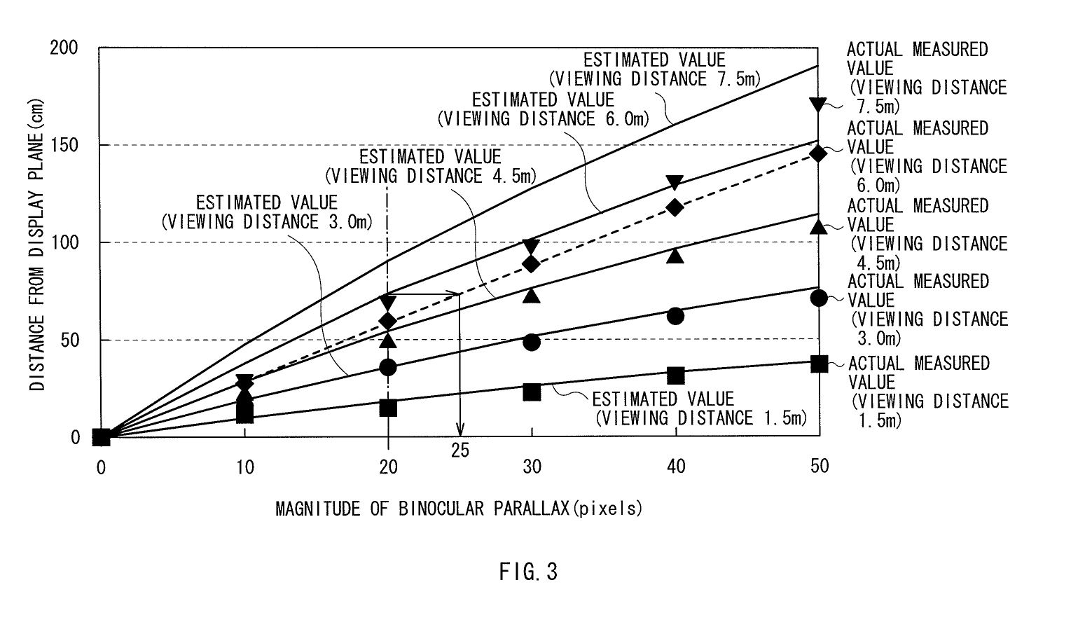

The correction factor retaining section 22 retains data for adjusting magnitude of parallax. The correction factor retaining section 22 retains first relationship data (data obtained from geometrically estimated values illustrated in FIG. 3 which will be described later) representing a correspondence relationship between magnitude of parallax and magnitude of depth perception without consideration of a decline in depth perception sensitivity. The correction factor retaining section 22 also retains second relationship data (data obtained from actual measured values illustrated in FIG. 3 which will be described later) representing a correspondence relationship between magnitude of parallax and magnitude of depth perception with consideration of a decline in depth perception sensitivity, the decline depending on the viewing distance.

The binocular parallax adjustment calculating section 23, the binocular parallax adjusting section 24, and the image producing section 25 adjust magnitude of parallax of input stereoscopic image data depending on the viewing distance to compensate for a decline in depth perception sensitivity of the viewer 1, thereby producing stereoscopic image data which is to be actually displayed on the display section 10. The input stereoscopic image data is image data including a plurality of parallax images according to the stereoscopic display system. The binocular parallax adjustment calculating section 23 calculates an adjustment value for the magnitude of parallax of the input stereoscopic image data, based on the correspondence relationship between magnitude of parallax and magnitude of depth perception stored in the correction factor retaining section 22. The binocular parallax adjusting section 24 allows the image producing section 25 to produce stereoscopic image data with adjusted magnitude of parallax, based on the calculated adjustment value for the magnitude of parallax. More specifically, the binocular parallax adjustment calculating section 23 calculates magnitude of depth perception corresponding to first magnitude-to-be-adjusted of parallax of stereoscopic image data, based on the first relationship data (geometrically estimated values which will be described later), and obtains, as an adjustment value for the magnitude of parallax, second magnitude of parallax corresponding to the calculated magnitude of depth perception from the second relationship data (an actual measured value which will be described later). The binocular parallax adjusting section 24 controls the image producing section 25 to modify the magnitude of parallax of the input stereoscopic image data from the first magnitude of parallax to the second magnitude of parallax. The display control section 26 allows stereoscopic image data with the adjusted magnitude of parallax produced by the image producing section 25 to be displayed on the display section 10.

### [Relationship Between Viewing Distance and Magnitude of Depth Perception]

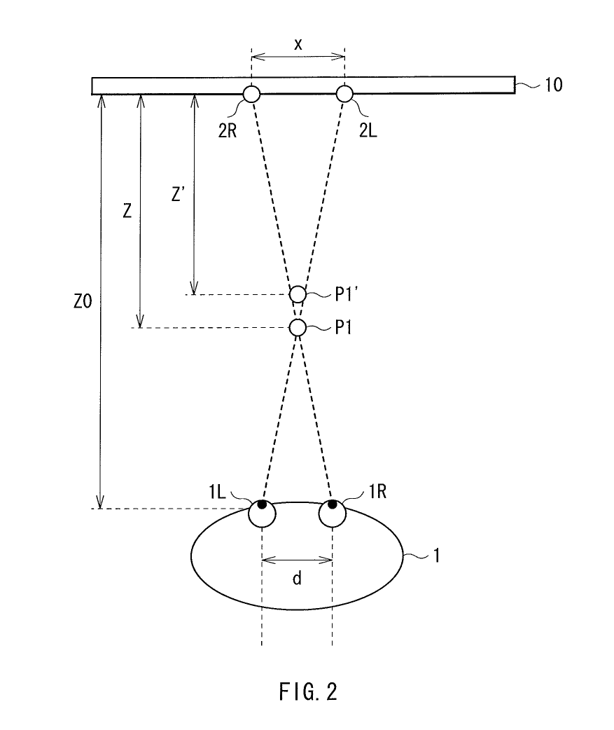

FIG. 2 illustrates a geometrical relationship between magnitude of parallax and magnitude of depth perception. In FIG. 2, a principle of stereoscopic vision in the case where an L (left-eye) image 2L and a R (right-eye) image 2R as parallax images are displayed on the display section 10 is schematically illustrated. The visibility (a stereoscopic effect, a sense of depth) of a stereoscopic image varies depending on a difference in magnitude of parallax. Assuming that the left-eye image 2L and the right-eye image 2R are located on the same pixel position on a reference plane (an image display plane of the display section 10), and the magnitude of parallax is zero, a left eye 1L and a right eye 1R of the viewer 1 see the same pixel position on the image display plane, and this is substantially the same as two-dimensional (2D) display. In this case, the displayed images do not have parallax therebetween, and the viewer 1 views actual images. On the other hand, FIG. 2 illustrates the case where the left-eye image 2L and the right-eye image 2R which have parallax therebetween are displayed. In particular, in FIG. 2, the right-eye image 2R is located on the left side of the left-eye image 2L on the reference plane (the image display plane). In this case, the viewer 1 perceives stereoscopic vision allowing the viewer 1 to view a virtual image appearing in front of the image display plane. In this case, a stereoscopic effect allowing an image to appear in front of the image display plane is obtained. The magnitude of depth in a state where an image is perceived in front of the image display plane is defined as, for example, a + direction, a stereoscopic effect that the larger the absolute magnitude of depth in the + direction is, the closer to the viewer 1 an image appears is obtained. It is to be noted that although not illustrated, in the case where the display positions of the left-eye image 2L and the right-eye image 2R are opposite to those in FIG. 2, that is, the right-eye image 2R is located on the right side of the left-eye image 2L on the image display plane, the viewer 1 perceives stereoscopic vision allowing the viewer 1 to view a virtual image appearing behind the image display plane.

As illustrated in FIG. 2, a distance from the image display plane to a position (a geometrically estimated position) P1 of the virtual image viewed by the viewer 1 is represented by the following formula according to the geometrical relationship, where Z0 is a viewing distance (a distance from the image display plane to a central position between both eyes of the viewer 1), d is a distance (a pupillary distance) between the left eye 1L and the right eye 1R, and x is a difference (magnitude of parallax) between the display positions of the left-eye image 2L and the right-eye image 2R on the image display plane.

Z(x)=Z0·x/(x+d) (1)

The above-described Z(x) is geometrically estimated theoretical magnitude of depth perception; however, depth perception sensitivity varies depending on the viewing distance Z0 according to human visual characteristics. In FIG. 2, P1′ is the position of a visual image actually viewed with consideration of the human visual characteristics, and Z′ is actual magnitude of depth perception.

FIG. 3 illustrates a correspondence relationship between magnitude of parallax and magnitude of depth perception. A horizontal axis indicates magnitude of binocular parallax (the magnitude x of parallax in FIG. 2), and a vertical axis indicates a distance from the image display plane to an image appearing in front of the image display plane (the magnitude Z or Z′ of depth perception in FIG. 2). In FIG. 3, solid lines each indicate a relationship (an estimated value) between geometrically estimated theoretical magnitude of depth perception and magnitude of parallax. Plot points such as black triangle marks each indicate a relationship (an actual measured value) between actually perceived magnitude of depth perception and magnitude of parallax. In particular, actual measured values in the case where the viewing distance is 6.0 m are indicated by a graph with black rhombus plots and a broken line. The correspondence relationship between magnitude of parallax and magnitude of depth perception varies depending on the viewing distance (the viewing distance Z0 in FIG. 2). FIG. 3 illustrates estimated values and actual measured values with graphs in the case where the viewing distance is 1.5 m, 3.0 m, 4.5 m, 6.0 m, and 7.5 m. It is to be noted that FIG. 3 illustrates results in the case where the display section 10 with a size of 40 inches has full-HD (1920×1080) resolution, and the pupillary distance d of the viewer 1 is a typical value of 65 mm.

FIG. 3 illustrates how close an object with certain parallax appears to the viewer 1 when the object is viewed at different distances. It is apparent that there is a tendency that the larger the viewing distance is, the less likely the viewer is to perceive the depth of the object appearing in front of the image display plane. Therefore, for example, in the case where the viewing distance is 6.0 m, to allow the viewer 1 to actually perceive estimated magnitude of depth perception in the case where the magnitude of parallax is 20 pixels, it is necessary to increase the magnitude of parallax to 25 pixels.

### [Operation of Stereoscopic Display]

It is apparent from FIG. 3 that to perceive actually intended magnitude of depth, it is necessary to adjust the magnitude of parallax depending on the viewing distance to compensate for a decline in depth perception sensitivity of the viewer 1. Therefore, in the stereoscopic display, the camera 11 takes an image of the viewer 1 whenever necessary. Then, the distance estimating section 21 detects the viewing distance of the viewer 1 by analyzing the image taken by the camera 11. Next, the binocular parallax adjustment calculating section 23 calculates an adjustment value for the magnitude of parallax of input stereoscopic image data based on data which represents the correspondence relationship between magnitude of parallax and magnitude of depth perception, and is stored in the correction factor retaining section 22. The binocular parallax adjusting section 24 allows the image producing section 25 to produce stereoscopic image data with adjusted magnitude of parallax based on the calculated adjustment value for the magnitude of parallax.

The first relationship data (data obtained from the geometrically estimated values illustrated in FIG. 3) representing the correspondence relationship between magnitude of parallax and magnitude of depth perception without consideration of a decline in depth perception sensitivity is retained in the correction factor retaining section 22 in advance. The second relationship data (data obtained from the actual measured values illustrated in FIG. 3) representing the correspondence relationship between magnitude of parallax and magnitude of depth perception with consideration of a decline, depending on the viewing distance, in depth perception sensitivity is also retained in the correction factor retaining section 22 in advance. The binocular parallax adjustment calculating section 23 calculates magnitude of depth perception corresponding to first magnitude-to-be-adjusted of parallax of stereoscopic image data based on the first relationship data (the geometrically estimated values), and obtains, as an adjustment value for the magnitude of parallax, second magnitude of parallax corresponding to the calculated magnitude of depth perception from the second relationship data (actual measured values). The binocular parallax adjusting section 24 controls the image producing section 25 to modify the magnitude of parallax of input stereoscopic image data from the first magnitude of parallax to the second magnitude of parallax. More specifically, for example, as illustrated in FIG. 3, when the magnitude-to-be-adjusted of parallax (the first magnitude of parallax) is 20 pixels in the case where the viewing distance is 6.0 m, the adjusted magnitude of parallax (the second magnitude of parallax) is changed to 25 pixels. Therefore, stereoscopic display with intended magnitude of depth perception for the viewer 1 is allowed to be performed.

### [Modification of Adjustment of Magnitude of Parallax]

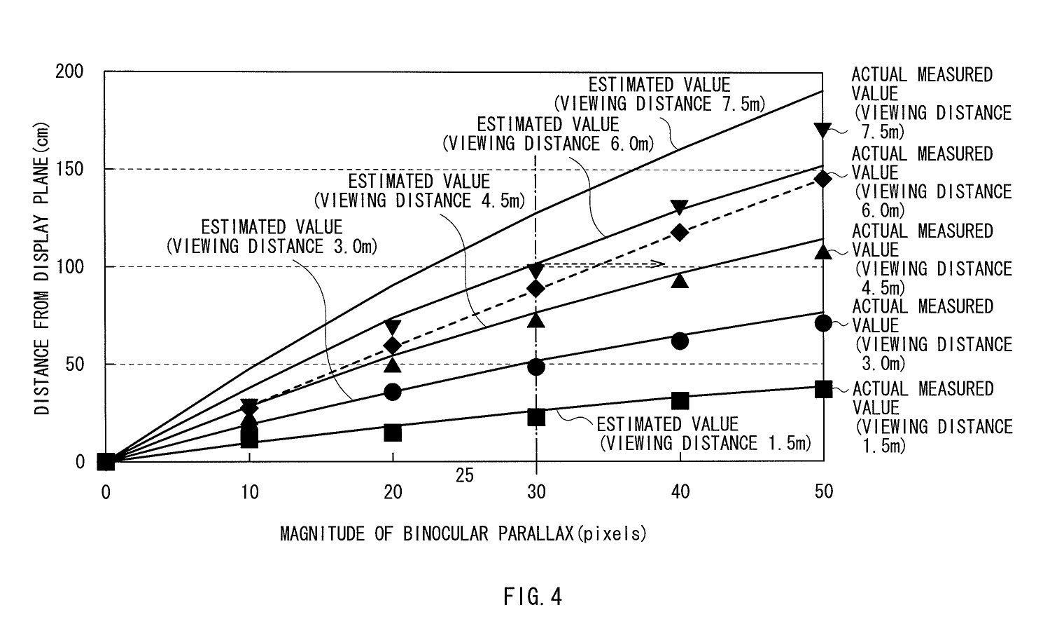

When the magnitude-to-be-adjusted of parallax (the first magnitude of parallax) of stereoscopic image data comes to be equal to or larger than a predetermined maximum value, to adjust the magnitude of parallax in the above-described manner, the magnitude of depth perception may be fixed while compensating for a decline in viewer's depth perception sensitivity. For example, as illustrated in FIG. 2, assuming that geometrically estimated magnitude of depth perception at the magnitude x of parallax is Z(x), and actual magnitude of depth perception is Z′, for example, in the case where the magnitude x of parallax is 30 pixels or over, the actual magnitude Z′ of depth perception is fixed at Z′=Z(30). Under viewing conditions that the display section 10 with a size of 40 inches has full-HD (1920×1080) resolution, and the pupillary distance d of the viewer 1 is 65 mm, as illustrated in FIG. 4, for example, in the case where the viewing distance is 1.5 m, the geometrically estimated magnitude Z(x) of depth perception at magnitude x of parallax of 30 pixels is 263 mm. Moreover, under the same viewing conditions, for example, in the case where the viewing distance is 6.0 m, the geometrically estimated magnitude Z(x) of depth perception at magnitude x of parallax of 30 pixels is 1053 mm. For example, in the case where the viewing distance is 6.0 m, and the magnitude x of parallax of input stereoscopic image data is 30 pixels or over, the magnitude of parallax is modified to fix the actual magnitude Z′ of depth perception at 1053 mm. In this case, the modified magnitude of parallax (the second magnitude of parallax) is determined based on data obtained from the actual measured values illustrated in FIG. 4. In other words, when the magnitude-to-be-adjusted of parallax (the first magnitude of parallax) comes to be equal to or larger than a predetermined maximum value (for example, 30 pixels), the binocular parallax adjustment calculating section 23 maintains the adjusted magnitude of parallax (the second magnitude of parallax) at a fixed value which corresponds to the predetermined maximum value. It is to be noted that the fixed value of the magnitude of depth perception may be determined based on, for example, preferences of a manufacturer or a viewer of the stereoscopic display.

### [First Modification of Calculation of Adjustment Value]

In the above description, the first and second relationship data representing the correspondence relationship between magnitude of parallax and magnitude of depth perception are retained in the correction factor retaining section 22, and the binocular parallax adjustment calculating section 23 calculates the second magnitude of parallax based on these two relationship data; however, the second magnitude of parallax may be calculated without directly using the magnitude of depth perception.

For example, a lookup table illustrated in the following Table 1 is retained as relationship data in the correction factor retaining section 22. The relationship data illustrated in Table 1 represents a mutual correspondence relationship among the viewing distance Z0, the first magnitude x of parallax (the magnitude-to-be-adjusted of parallax) and the second magnitude x′ of parallax (the adjusted magnitude of parallax). The second magnitude x′ of parallax is a value obtained by adding an adjustment value Ax to the first magnitude x of parallax. The adjustment value Ax is determined in advance from data obtained from the geometrically estimated values illustrated in FIG. 3 and data obtained from the actual measured values illustrated in FIG. 3. Accordingly, the second magnitude x′ of parallax is a value optimized to compensate the first magnitude x of parallax for a decline in viewer's depth perception sensitivity, the decline depending on the viewing distance Z0. The correspondence relationship between the first magnitude x of parallax and the second magnitude x′ of parallax varies depending on the viewing distance Z0. In the binocular parallax adjustment calculating section 23, the adjustment value (the second magnitude x′ of parallax) for the magnitude of parallax of input stereoscopic image data is calculated based on relationship data illustrated in Table 1. The binocular parallax adjusting section 24 allows the image producing section 25 to produce stereoscopic image data with adjusted magnitude of parallax, based on the calculated second magnitude x′ of parallax.

TABLE 1
[Second modification of calculation of adjustment value]

| | | | Adjusted |
|---|---|---|---|
| | Magnitude-to-be- | | Magnitude (Second |
| Viewing | adjusted × (First | Adjustment value | Magnitude) x + Δx |
| Distance Z0 | Magnitude) of | Δx | of Parallax |
| (m) | Parallax (pixel) | (pixel) | (pixel) |
| 1.5 | 10 | 0 | 10 |
| 1.5 | 20 | 1 | 21 |
| 1.5 | 30 | 1 | 31 |
| 1.5 | 40 | 1 | 41 |
| 3 | 10 | 0 | 10 |
| 3 | 20 | 1 | 21 |
| 3 | 30 | 2 | 32 |
| 3 | 40 | 3 | 43 |
| 4.5 | 10 | 2 | 12 |
| 4.5 | 20 | 2 | 22 |
| 4.5 | 30 | 3 | 33 |
| 4.5 | 40 | 3 | 43 |
| 6 | 10 | 2 | 12 |
| 6 | 20 | 5 | 25 |
| 6 | 30 | 5 | 35 |
| 6 | 40 | 5 | 45 |
| 7.5 | 10 | 5 | 15 |
| 7.5 | 20 | 7 | 27 |
| 7.5 | 30 | 9 | 39 |
| 7.5 | 40 | 9 | 49 |

In the above description, the correspondence relationship between the first magnitude x of parallax and the second magnitude x′ of parallax is variable depending on the viewing distance Z0; however, the magnitude of parallax may be also variably controlled according to the pupillary distance d (a distance between both eyes) of the viewer 1. It is apparent from FIG. 2 and the above-described formula (1) that the magnitude Z(x) of depth perception also varies depending on the pupillary distance d. Table 2 illustrates an example of a correspondence relationship between the magnitude x of parallax and the geometrically estimated theoretical magnitude Z(x) of depth perception depending on the viewing distance Z0 and the pupillary distance d. It is to be noted that a relationship between the magnitude x of parallax and the magnitude Z(x) of depth perception in the case of the pupillary distance d=65 mm in Table 2 corresponds to graphs with solid lines in FIGS. 3 and 4 in the case where the viewing distance is 1.5 m, 3.0 m, and 6.0 m.

In the modification, the distance estimating section 21 detects the pupillary distance d in addition to the viewing distance Z0 of the viewer 1 by analyzing an image taken by the camera 11. For example, relationship data representing a mutual correspondence relationship among the pupillary distance d, the viewing distance Z0, the first magnitude x of parallax (magnitude-to-be-adjusted of parallax), and the second magnitude x′ of parallax (adjusted magnitude of parallax) is stored in the correction factor retaining section 22. For example, a lookup table illustrated in Table 1 in the above-described first modification is determined at each of a plurality of estimated pupillary distances d to be stored as relationship data. The binocular parallax adjustment calculating section 23 calculates an adjustment value (the second magnitude x′ of parallax) for the magnitude of parallax of the input stereoscopic image data, based on relationship data corresponding to the viewing distance Z0 and the pupillary distance d. The binocular parallax adjusting section 24 allows the image producing section 25 to produce stereoscopic image data with adjusted magnitude of parallax, based on the calculated second magnitude of parallax.

TABLE 2

| Viewing Distance Z0 (m) | | Magnitude of Depth Perception Z (mm) | | | | |
|---|---|---|---|---|---|---|
| Magnitude of Parallax | | Pupillary Distance (Distance between both eyes) d (mm) | | | | |
| x (pixels) | x (mm) | 50 | 55 | 60 | 65 | 70 |
| | | 1.5 | | | | |
| 0 | 0.0 | 0.0 | 0.0 | 0.0 | 0.0 | 0.0 |
| 5 | 2.3 | 66.1 | 60.3 | 55.5 | 51.4 | 47.8 |
| 10 | 4.6 | 126.6 | 116.0 | 107.0 | 99.3 | 92.7 |
| 15 | 6.9 | 182.2 | 167.5 | 155.0 | 144.2 | 134.9 |
| 20 | 9.2 | 233.5 | 215.4 | 199.8 | 186.3 | 174.6 |
| 25 | 11.5 | 281.0 | 259.9 | 241.7 | 225.9 | 212.1 |
| 30 | 13.8 | 325.0 | 301.4 | 281.0 | 263.2 | 247.5 |
| 35 | 16.1 | 366.0 | 340.2 | 317.9 | 298.3 | 281.0 |
| 40 | 18.4 | 404.1 | 376.6 | 352.6 | 331.5 | 312.8 |
| 45 | 20.7 | 439.9 | 410.8 | 385.4 | 362.9 | 342.9 |
| 50 | 23.1 | 473.3 | 443.0 | 416.3 | 392.7 | 371.6 |
| | | 3.0 | | | | |
| 0 | 0.0 | 0.0 | 0.0 | 0.0 | 0.0 | 0.0 |
| 5 | 2.3 | 132.2 | 120.7 | 111.0 | 102.7 | 95.6 |
| 10 | 4.6 | 253.3 | 232.0 | 214.1 | 198.7 | 185.4 |
| 15 | 6.9 | 364.5 | 335.1 | 310.0 | 288.5 | 269.7 |
| 20 | 9.2 | 467.1 | 430.7 | 399.6 | 372.7 | 349.2 |
| 25 | 11.5 | 562.0 | 519.7 | 483.4 | 451.8 | 424.1 |
| 30 | 13.8 | 650.0 | 602.8 | 562.0 | 526.3 | 494.9 |
| 35 | 16.1 | 731.9 | 680.5 | 635.8 | 596.6 | 562.0 |
| 40 | 18.4 | 808.3 | 753.3 | 705.3 | 663.0 | 625.5 |
| 45 | 20.7 | 879.7 | 821.6 | 770.8 | 725.8 | 685.8 |
| 50 | 23.1 | 946.6 | 886.0 | 832.6 | 785.3 | 743.1 |
| | | 6.0 | | | | |
| 0 | 0.0 | 0.0 | 0.0 | 0.0 | 0.0 | 0.0 |
| 5 | 2.3 | 264.4 | 241.3 | 222.0 | 205.5 | 191.3 |
| 10 | 4.6 | 506.5 | 464.0 | 428.1 | 397.4 | 370.7 |
| 15 | 6.9 | 729.0 | 670.1 | 620.0 | 576.9 | 539.4 |
| 20 | 9.2 | 934.1 | 861.4 | 799.2 | 745.4 | 698.3 |
| 25 | 11.5 | 1123.9 | 1039.5 | 966.8 | 903.6 | 848.2 |
| 30 | 13.8 | 1300.0 | 1205.6 | 1123.9 | 1052.6 | 989.9 |
| 35 | 16.1 | 1463.8 | 1360.9 | 1271.6 | 1193.2 | 1123.9 |
| 40 | 18.4 | 1616.6 | 1506.5 | 1410.5 | 1326.0 | 1251.0 |
| 45 | 20.7 | 1759.4 | 1643.3 | 1541.5 | 1451.6 | 1371.6 |
| 50 | 23.1 | 1893.2 | 1771.9 | 1665.3 | 1570.7 | 1486.3 |

### [Effects]

As described above, in the stereoscopic display according to the embodiment, the magnitude of parallax of stereoscopic image data is adjusted depending on the viewing distance to compensate for a decline in the depth perception sensitivity; therefore, irrespective of the viewing distance, favorable stereoscopic display is allowed to be performed with intended magnitude of depth perception. The magnitude of depth perception declines with an increase in the viewing distance according to human visual characteristics; however, in the stereoscopic display according to the embodiment, even in the case where the viewing distance is increased, a decline in the magnitude of depth perception is suppressed.

### Other Embodiments

The present technology is not limited to the above-described embodiment, and may be variously modified.

For example, the technology is allowed to have the following configurations.

(1) A display including:

a display section displaying a stereoscopic image based on stereoscopic image data;

a detection section detecting a viewing distance of a viewer; and

an adjustment section modifying magnitude of parallax of the stereoscopic image data from first magnitude of parallax to second magnitude of parallax,

in which the adjustment section modifies a correspondence relationship between the first magnitude of parallax and the second magnitude of parallax depending on the detected viewing distance.

(2) The display according to (1), in which

the second magnitude of parallax has a value optimized to compensate the first magnitude of parallax for a decline in viewer's depth perception sensitivity, the decline depending on the viewing distance.

(3) The display according to (1) or (2), further including a storage section holding relationship data representing a mutual correspondence relationship among the viewing distance, the first magnitude of parallax, and the second magnitude of parallax,

in which the adjustment section modifies the magnitude of parallax of the stereoscopic image data from the first magnitude of parallax to the second magnitude of parallax based on the relationship data.

(4) The display according to any one of (1) to (3), in which

when the first magnitude of parallax comes to be equal to or larger than a predetermined maximum value, the adjustment section maintains the second magnitude of parallax at a fixed value which corresponds to the predetermined maximum value.

(5) The display according to any one of (1), (2) and (4), further including a storage section holding first relationship data and second relationship data, the first relationship representing a correspondence relationship between magnitude of parallax and magnitude of depth perception without consideration of a decline in depth perception sensitivity, the second relationship data representing a correspondence relationship between magnitude of parallax and magnitude of depth perception with consideration of a decline in depth perception sensitivity, the decline depending on the viewing distance,

in which the adjustment section calculates magnitude of depth perception corresponding to the first magnitude of parallax based on the first relationship data, and obtains, from the second relationship data, the second magnitude of parallax corresponding to the calculated magnitude of depth perception.

(6) The display according to any one of (1), (2) and (4), in which

the detection section further detects a pupillary distance of a viewer, and

the adjustment section modifies the correspondence relationship between the first magnitude of parallax and the second magnitude of parallax depending on both the detected viewing distance and the detected pupillary distance.

(7) The display according to (6), further including a storage section holding relationship data representing a mutual correspondence relationship among the pupillary distance, the viewing distance, the first magnitude of parallax, and the second magnitude of parallax,

in which the adjustment section modifies the magnitude of parallax of the stereoscopic image data from the first magnitude of parallax to the second magnitude of parallax based on the relationship data.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display comprising:
a display section displaying a stereoscopic image based on stereoscopic image data;
a detection section detecting a viewing distance of a viewer; and
an adjustment section modifying magnitude of parallax of the stereoscopic image data from first magnitude of parallax to second magnitude of parallax,
wherein the adjustment section modifies a correspondence relationship between the first magnitude of parallax and the second magnitude of parallax depending on the detected viewing distance.

2. The display according to claim 1, wherein
the second magnitude of parallax has a value optimized to compensate the first magnitude of parallax for a decline in viewer's depth perception sensitivity, the decline depending on the viewing distance.

3. The display according to claim 1, further comprising a storage section holding relationship data representing a mutual correspondence relationship among the viewing distance, the first magnitude of parallax, and the second magnitude of parallax,
wherein the adjustment section modifies the magnitude of parallax of the stereoscopic image data from the first magnitude of parallax to the second magnitude of parallax based on the relationship data.

4. The display according to claim 1, wherein
when the first magnitude of parallax comes to be equal to or larger than a predetermined maximum value, the adjustment section maintains the second magnitude of parallax at a fixed value which corresponds to the predetermined maximum value.

5. The display according to claim 1, further comprising a storage section holding first relationship data and second relationship data, the first relationship data representing a correspondence relationship between magnitude of parallax and magnitude of depth perception without consideration of a decline in depth perception sensitivity, the second relationship data representing a correspondence relationship between magnitude of parallax and magnitude of depth perception with consideration of a decline in depth perception sensitivity, the decline depending on the viewing distance,
wherein the adjustment section calculates magnitude of depth perception corresponding to the first magnitude of parallax based on the first relationship data, and obtains, from the second relationship data, the second magnitude of parallax corresponding to the calculated magnitude of depth perception.

6. The display according to claim 1, wherein
the detection section further detects a pupillary distance of a viewer, and
the adjustment section modifies the correspondence relationship between the first magnitude of parallax and the second magnitude of parallax depending on both the detected viewing distance and the detected pupillary distance.

7. The display according to claim 6, further comprising a storage section holding relationship data representing a mutual correspondence relationship among the pupillary distance, the viewing distance, the first magnitude of parallax, and the second magnitude of parallax,
wherein the adjustment section modifies the magnitude of parallax of the stereoscopic image data from the first magnitude of parallax to the second magnitude of parallax based on the relationship data.

8. A display comprising:
a display section displaying an image based on image data;
a detection section detecting a viewer; and
an adjustment section modifying magnitude of parallax of the image data,
wherein the adjustment section modifies, depending on a distance to the viewer, the magnitude of parallax of the image data to compensate for a decline in viewer's depth perception sensitivity.

9. A displaying method comprising:
detecting a viewing distance;
modifying magnitude of parallax of stereoscopic image data from first magnitude of parallax to second magnitude of parallax; and
displaying a stereoscopic image based on the modified stereoscopic image data,
wherein in modification to the second magnitude of parallax, a correspondence relationship between the first magnitude of parallax and the second magnitude of parallax is modified depending on the detected viewing distance.
